(19) United States
(12) Patent Application Publication
(10) Pub. No.: US 2025/0336244 A1
(43) Pub. Date: Oct. 30, 2025

(54) METHOD AND SYSTEM FOR PROVIDING VEHICLE DIAGNOSTICS

(71) Applicant: Continental Automotive Technologies GmbH, Hannover (DE)

(72) Inventor: Mohamed Uvais Mohamed Kamaldeen, Singapore (SG)

(73) Assignee: Continental Automotive Technologies GmbH, Hannover (DE)

(21) Appl. No.: 19/191,334

(22) Filed: Apr. 28, 2025

(30) Foreign Application Priority Data
Apr. 30, 2024 (GB) 2406017.0

(51) Int. Cl. G07C 5/00; G07C 5/08

(52) U.S. Cl. CPC G07C 5/008; G07C 5/0808

(57) ABSTRACT

Vehicle diagnostics are provided by determining a vehicle status associated with one or more vehicle faults; obtaining data based on the vehicle status, the data comprising video data and/or image data of the one or more vehicle faults; and transmitting the data to a user device.

### CROSS-REFERENCE TO RELATED APPLICATIONS

The present application claims the benefit and/or priority of Great Britian Patent Application 2406017.0 filed on Apr. 30, 2024, the content of which is incorporated by reference herein.

### FIELD OF INVENTION

This invention generally relates to methods and systems for providing vehicle diagnostics.

### BACKGROUND OF INVENTION

Currently, vehicle faults, such as but not limited to diagnostic trouble code (DTC) or freeze frame data (FFD) or Snapshopt Record (SSR), are collected from electronic control units (ECUs) via data collection module (DCM). However, the vehicle faults collected may only contain fault information and further investigation and severity of the fault can only be determined after taking the vehicle to a vehicle service center for a physical check. This may lead to several problems, for example not being able to take the vehicle to the vehicle service center quickly because the vehicle driver or owner may not understand the severity of the fault. Consequently, the driver may continue to use the faulty vehicle and there may be a potential for an accident.

There is therefore a need to provide a method and system that will overcome and at least ameliorate one or more of the disadvantages discussed above.

### BRIEF SUMMARY

It is an object to provide a method and system that address one or more of the problems discussed above.

According to a first aspect of the present invention, there is provided a method for providing vehicle diagnostics, comprising: determining a vehicle status associated with one or more vehicle faults; obtaining data based on the vehicle status, the data comprising video data and/or image data of the one or more vehicle faults; and transmitting the data to a user device.

Advantageously, the method as provided herein may provide increased awareness to the vehicle driver or owner as compared to only receiving the fault signal in the vehicle. In addition, repairs on the vehicle fault can be done quickly without the need to perform a physical investigation, where vehicle components are removed in order to find the fault or problem.

In an embodiment, determining the vehicle status comprises obtaining a vehicle fault code related to the one or more vehicle faults.

In an embodiment, the method further includes capturing video data and/or image data of the one or more vehicle faults by a video capturing module and/or an image capturing module.

In an embodiment, the method further includes pre-determining a position of the video capturing module and a position of the image capturing module.

In an embodiment, transmitting the data comprises transmitting real-time video data and/or real-time image data to the user device.

In an embodiment, the method further includes requesting data of the vehicle status; obtaining the data including live video data and/or live image data; and transmitting the data including live video data and/or live image data to the user device.

According to a second aspect of the present invention, there is provided a system for providing vehicle diagnostics, comprising: one or more vehicle units; one or more user devices; a server, wherein the server is configured to: determine a vehicle status associated with one or more vehicle faults; obtain data based on the vehicle status, the data comprising video data and/or image data of the one or more vehicle faults; and transmit the data to the one or more user devices.

Advantageously, the system as disclosed can be used in existing vehicle telematics products or any electronic control unit (ECU) with data connectivity without the need for new hardware. Vehicle manufactures may also benefit from time savings by having online investigation of the vehicle fault.

In an embodiment, the server is further configured to obtain a vehicle fault code related to the one or more vehicle faults.

In an embodiment, the one or more vehicle units are further configured to capture video data and/or image data of the one or more vehicle faults by a video capturing module and/or an image capturing module.

In an embodiment, the server is further configured to pre-determine a position of the video capturing module and a position of the image capturing module.

In an embodiment, the server is further configured to provide real-time video data and/or real-time image data to the one or more user devices.

In an embodiment, the one or more user devices are configured to request data of the vehicle status.

In an embodiment, the server is further configured to: obtain data of the vehicle status including live video data and/or live image data; and transmit the data including live video data and/or live image data to the one or more user devices.

### BRIEF DESCRIPTION OF DRAWINGS

Embodiments will be better understood and readily apparent to one of ordinary skill in the art from the following written description, by way of example only, and in conjunction with the drawings, in which:

FIG. 1 shows a flow chart illustrating a method for providing vehicle diagnostics in accordance with an embodiment of the invention.

FIG. 2 shows a diagram illustrating a system for providing vehicle diagnostics in accordance with an embodiment of the invention.

FIG. 3 shows a schematic diagram illustrating the flow of information for providing vehicle diagnostics in accordance with an embodiment of the invention.

Like numerals denote like parts.

### DETAILED DESCRIPTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

The present disclosure also discloses a user device or user devices. It will be appreciated the user device or the user devices can include potentially any device which has a wireless communication and sensing Transmitter and Receiver system using potentially any or all of a multiplicity of Wireless communication standards such as Bluetooth (BLE), Wi-Fi, 4G, 5G, mmWave, Terahertz, or any other future wireless standards. The user device or user devices can include all the requisite wireless communication standards that are necessary for this functionality and includes the possibility of extensive authentication features using onboard computing power as well as potential cloud-based computing power.

Similarly, the present specification also discloses a vehicle unit (vehicle device) or vehicle units (vehicle devices). It will be appreciated the vehicle unit or vehicle units can include potentially any device which has a wireless communication and sensing Transmitter and Receiver system using potentially any or all of a multiplicity of Wireless communication standards like Bluetooth (BLE), WIFI, 4G, 5G, mmWave, Terahertz, or any other future wireless standards. The vehicle unit or vehicle units can include all the requisite wireless communication standards that are necessary for this functionality and includes the possibility of extensive authentication features using onboard computing power as well as potential cloud-based computing power.

In embodiments of the present invention, use of the term ‘server’ may mean a single computing device or at least a computer network of interconnected computing devices which operate together to perform a particular function. In other words, the server may be contained within a single hardware unit or be distributed among several or many different hardware units. It can be appreciated that the server is capable of wireless communication and sensing, including a Transmitter and Receiver system using potentially any or all of a multiplicity of Wireless communication standards like Bluetooth (BLE), WIFI, 4G, 5G, mmWave, Terahertz, or any other future wireless standards. The server can include all the requisite wireless communication standards that are necessary for this functionality and includes the possibility of extensive authentication features using onboard computing power as well as potential cloud-based computing power.

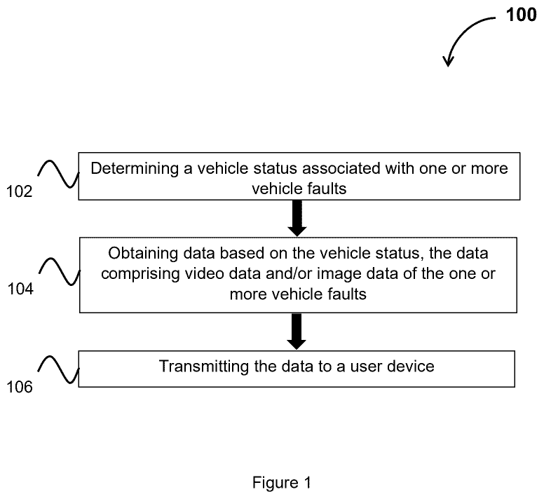

FIG. 1 shows a flow chart illustrating a method 100 for providing vehicle diagnostics in accordance with an embodiment of the invention. At step 102, the method 100 includes determining a vehicle status associated with one or more vehicle faults. This may include obtaining a vehicle fault code related to the one or more vehicle faults. For example, a vehicle may encounter a problem such as engine overheating and an electronic control unit (ECU) may obtain or receive the vehicle fault code P0217 which indicates the engine has an overtemperature condition.

At step 104, the method 100 includes obtaining data based on the vehicle status, the data comprising video data and/or image data of the one or more vehicle faults. This may include capturing video data and/or image data of the one or more vehicle faults by a video capturing module and/or an image capturing module. The position of the video capturing module and the position of the image capturing module can be pre-determined and pre-installed in the respective areas of the vehicle.

At step 106, the method 100 includes transmitting the data to a user device. This may include transmitting real-time video data and/or real-time image data of the vehicle fault to the user device. In an alternate embodiment, live video and/or live image data of the vehicle fault may also be transmitted to the user device.

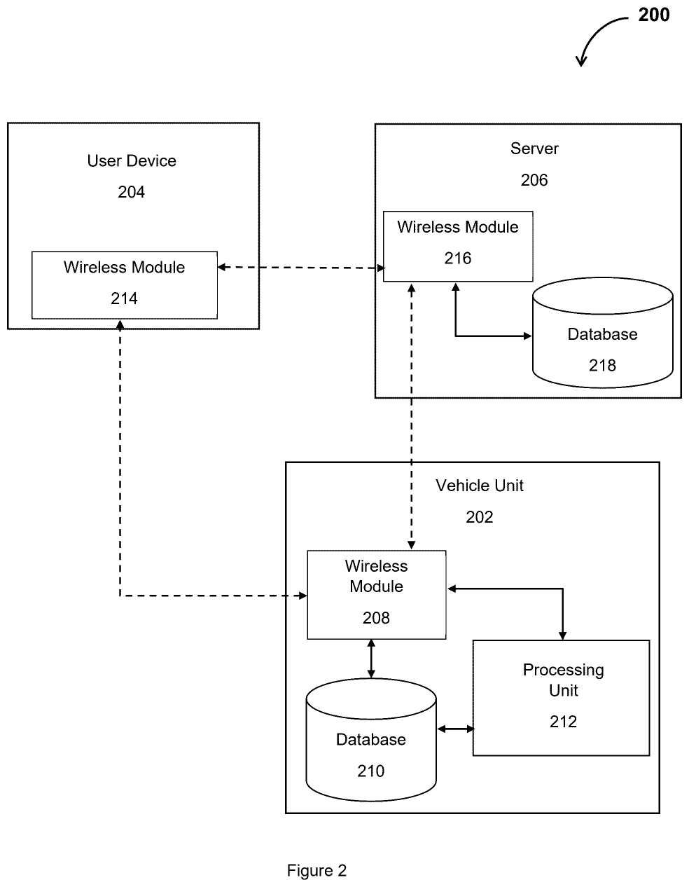

FIG. 2 shows a diagram illustrating a system 200 for providing vehicle diagnostics in accordance with an embodiment of the invention. Specifically, the Figure illustrates wireless communication between a vehicle unit 202, a user device 204 and a server 206. The wireless communication may be via Low Frequency (LF), Radio Frequency (RF), Microwave and millimetre wave (mmWave) or higher frequencies, using any wireless communication method or standard defined or proprietary, with a transmitter (TX) and receiver (RX) defined for the vehicle wireless unit 202, the user wireless device 204 as well as the server 206. The wireless communication may also involve associated keys, authentication protocol, and other peripheral features, like a database and/or the use of the controller, encryption and decryption methods, computer or other computing or actuating devices. It can be appreciated more than one vehicle unit 202 and user device 204 may be present in the system. For example the vehicle unit(s) 202 may include but not limited to a transmission control unit (TCU), a data control module (DCM), an advanced driver-assistance system (ADAS) and/or any other vehicle electronic control unit (ECU).

To overcome the loss of data or to overcome inaccuracies in the accumulated data collected or other information collected and transmitted from the vehicle unit(s) 202, it may be necessary to define the vehicle and its system when referring to one user device 204, one vehicle unit 202 and one server 206 during the process of providing vehicle diagnostics to a user. While the actual system may have a plurality of user devices, a plurality of vehicle units and/or a plurality of servers, the user device 204, the vehicle unit 202 and the server 206 are a set of interoperable devices that can communicate with each other to and from, using an uplink or downlink, half duplex or full duplex mode of communication with periodic wireless information transfer, wireless synchronization, device wakeup and other wireless functionality needed to provide a robust communication platform and regular operation.

The vehicle unit 202 includes a wireless module 208, a database 210 and a processing unit 212. The wireless module 208 may be communication with the server 206 and the user device 204. The vehicle unit 202 may be configured to capture video data and/or image data of one or more vehicle faults by a video capturing module and/or an image capturing module (not shown in the Figure). In an example embodiment, the vehicle may encounter a problem (e.g. engine overheat) and may trigger a vehicle fault code, for example but not limited to diagnostic trouble code DTC or freeze frame data FFD or Snapshopt Record SSR. The vehicle unit 202 may then collect video and/or image evidence of the vehicle fault from any ECU via the processing unit 212. For example, the video and image data can be collected from an ADAS ECU by a camera in proximity to the vehicle fault area. The collected vehicle fault (e.g. DTC/FFD/SSR) may be uploaded together with the captured image and/or recorded video to the server 206 via the wireless module 208.

The user device 204 may include a wireless module 214 that is in communication with the server 206 and the vehicle unit 202. The user device 204 may be configured to request data of the vehicle status that is associated with one or more vehicle faults. In an example embodiment, the vehicle may encounter a problem (e.g. engine overheat) and may trigger a vehicle fault code, for example but not limited to DTC or FFD or SSR. The vehicle status and fault code may be transmitted to the user device 204, such as a mobile phone of a vehicle service person. The service person can then request, via the mobile phone or user device 204, for live video streaming or live images of the vehicle fault area for a detailed investigation. This can allow the service person to easily visualize the problem and quickly reach out to the vehicle owner or driver to bring the vehicle to a service station for repair.

The server 206 may include a wireless module 216 that is in communication with the vehicle unit 202 and the user device 204. The server 206 may also include a database 218 that may store data, such as vehicle status data, and is communicable with the wireless module 216. The server 206 is configured to determine a vehicle status associated with one or more vehicle faults; obtain data based on the vehicle status, the data comprising video data and/or image data of the one or more vehicle faults; and transmit the data to the one or more user devices. The server 206 may also be configured to obtain a vehicle fault code related to the one or more vehicle faults and pre-determine a position of the video capturing module and a position of the image capturing module. For example, the server 206 may choose and configure the camera from ADAS depending on the vehicle configuration or type as well as the DTC.

The server 206 may also provide real-time video data and/or real-time image data to the one or more user devices; obtain data of the vehicle status including live video data and/or live image data; and transmit the data including live video data and/or live image data to the one or more user devices.

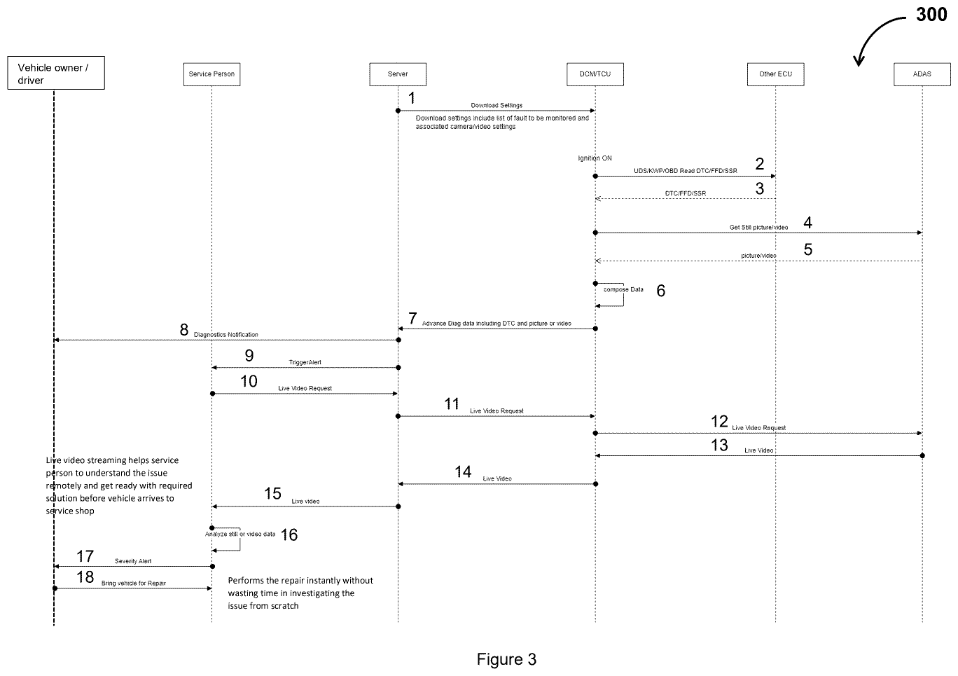

FIG. 3 shows a schematic diagram illustrating the flow of information for providing vehicle diagnostics in accordance with an embodiment of the invention. At step 1, the server 206 may pre-determine (or configure) and download settings to a vehicle unit 202, such as a transmission control unit (TCU) or a data control module (DCM) located in a vehicle. The settings may include a list of faults to be monitored, associated camera and/or video settings and a position of the camera. At step 2, the vehicle unit 202 (or TCU or DCM) may read vehicle fault from other electronic control unit (ECU) such as DTC/FFD/SSR using Unified Diagnostic Services (UDS) or Keyword Protocol (KWP) or on-board diagnostics (OBD) after the vehicle ignition is turned on.

At step 3, the ECUs transmits the relevant data (e.g. DTC/FFD/SSR) to the vehicle unit 202 (e.g. DCM or TCU). At step 4, the vehicle unit 202 (e.g. DCM or TCU) obtains still images and/or video from a different vehicle unit 202 (e.g. advanced driver-assistance system (ADAS)) and the ADAS transmits the relevant picture and/or video back to the vehicle unit 202 (e.g. DCM or TCU) at step 5. At step 6, the vehicle unit 202 (e.g. DCM or TCU) composes the received data and transmits, at step 7, advanced diagnostic data, including DTC, picture and/or video, to the server 206.

At step 8, the server 206 transmits a diagnostic notification to a user device 204, such as a smart phone, of a vehicle owner or vehicle driver. At the same time, the server 206 may also trigger or alert the diagnostic notification to a service person via his/her user device 204 at step 9. The service person in this example context may be a mechanic at a car workshop or a person that may provide vehicle aftermarket services. At step 10, the service person may request live video from the server 206 via his/her user device 204. At step 11, the server 206 may transmit this request to the vehicle unit 202 (e.g. DCM or TCU), which in turn transmits the request to another vehicle unit (e.g. ADAS) at step 12. At step 13, the ADAS may provide the live video to the vehicle unit (e.g. DCM or TCU), which in turn provides it to the server 206 at step 14.

At step 15, the server 206 may then transmit the live video to the service person via his/her user device 202. The live video streaming may help the service person to understand the vehicle problem remotely and may prepare the necessary remedy before the vehicle arrives at his/her service center. This can be done when the service person analyses the still images or video data at step 16. At step 17, a severity alert may be transmitted by the user device 204 of the service person to the user device 204 of the vehicle owner or driver. Subsequently at step 18, the vehicle owner or driver brings the vehicle for repair. The repair may be performed instantly without wasting time in investigating the issue from scratch, or by removing and analysing individual vehicle components.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for providing vehicle diagnostics, comprising:
determining a vehicle status associated with one or more vehicle faults;
obtaining data based on the vehicle status, the data comprising video data and/or image data of the one or more vehicle faults; and
transmitting the data to a user device,
wherein transmitting the data comprises transmitting real-time video data and/or real-time image data to the user device prior to vehicle servicing.

2. The method according to claim 1, wherein determining the vehicle status comprises obtaining a vehicle fault code related to the one or more vehicle faults.

3. The method according to claim 1, further comprising capturing video data and/or image data of the one or more vehicle faults by a video capturing module and/or an image capturing module.

4. The method according to claim 3, further comprising pre-determining a position of the video capturing module and a position of the image capturing module.

5. The method according to claim 1, further comprising:
requesting data of the vehicle status;
obtaining the data including live video data and/or live image data; and
transmitting the data including live video data and/or live image data to the user device.

6. A system for providing vehicle diagnostics, comprising:
one or more vehicle units;
one or more user devices;
a server, wherein the server is configured to:
determine a vehicle status associated with one or more vehicle faults;
obtain data based on the vehicle status, the data comprising video data and/or image data of the one or more vehicle faults;
transmit the data to the one or more user devices; and
provide real-time video data and/or real-time image data to the one or more user devices) prior to vehicle servicing.

7. The system according to claim 6, wherein the server is further configured to obtain a vehicle fault code related to the one or more vehicle faults.

8. The system according to claim 6, wherein the one or more vehicle units are further configured to capture video data and/or image data of the one or more vehicle faults by a video capturing module and/or an image capturing module.

9. The system according to claim 8, wherein the server is further configured to pre-determine a position of the video capturing module and a position of the image capturing module.

10. The system according to claim 6, wherein the one or more user devices are configured to request data of the vehicle status.

11. The system according to claim 6, wherein the server is further configured to:
obtain data of the vehicle status including live video data and/or live image data; and
transmit the data including live video data and/or live image data to the one or more user devices.
